(19) United States
(12) Patent Application Publication
(10) Pub. No.: US 2009/0179569 A1
(43) Pub. Date: Jul. 16, 2009

(54) PLASMA DISPLAY PANEL AND MANUFACTURING METHOD OF THE SAME

(76) Inventors: Tae-Seung Cho, Suwon-si (KR); Young-Do Choi, Suwon-si (KR); Jae-Ik Kwon, Suwon-si (KR); Byoung-Min Chun, Suwon-si (KR); Won-Yi Lee, Suwon-si (KR); Kwang-Sik Lee, Suwon-si (KR)

Correspondence Address: CHRISTIE, PARKER & HALE, LLP, PO BOX 7068, PASADENA, CA, 91109-7068, US

(21) Appl. No.: 12/345,501

(22) Filed: Dec. 29, 2008

(30) Foreign Application Priority Data
Jan. 15, 2008 (KR) 10-2008-0004471

(51) Int. Cl. H01J 17/49; H01J 9/24

(52) U.S. Cl. 313/587; 313/586; 445/24

(57) ABSTRACT

A plasma display panel including: a front panel including a front substrate, a sustain electrode on a surface of the front substrate extending in one direction and including an X electrode and a Y electrode, and a first dielectric layer including an anodized material of the sustain electrode on a surface of the sustain electrode not contacting the front substrate; a rear panel facing the front panel, and including a rear substrate, an address electrode on one surface of the rear substrate facing the front substrate, and a second dielectric layer covering the address electrode; and a barrier rib partitioning a plurality of discharge cells between the front panel and the rear panel in a pattern.

### CROSS-REFERENCE TO RELATED APPLICATIONS

This application claims priority to and the benefit of Korean Patent Application No. 10-2008-0004471, filed on Jan. 15, 2008 in the Korean Intellectual Property Office, the entire content of which is incorporated herein by reference.

### BACKGROUND OF THE INVENTION

1. Field of the Invention

The present invention relates to a plasma display panel, and more specifically to a plasma display panel having a dielectric layer formed by anodization.

2. Description of Related Art

Plasma display panels may be a DC type, an AC type, or a hybrid type according to an applied discharge voltage, and a facing discharge type or a surface discharge type according to a discharge structure.

In the case of the AC type plasma display panel, a discharge cell is defined by a front substrate, a rear substrate, and a barrier rib, and a three-electrode surface discharge structure including an X electrode, a Y electrode, and an electrode crossing the X electrode and Y electrode is well known.

However, this three-electrode surface discharge structure has a discharge distance between the electrodes that is long so that discharge voltage becomes high.

Therefore, there is a need for a plasma display panel having a new electrode structure.

### SUMMARY OF THE INVENTION

Aspects of embodiments of the present invention are directed toward a plasma display panel and a manufacturing method of the same in which a dielectric layer is provided by anodizing the outer surface of a sustain electrode not contacting a front substrate.

An embodiment of the present invention provides a plasma display panel including: a front panel including a front substrate, a sustain electrode on a surface of the front substrate extending in one direction and including an X electrode and a Y electrode, and a first dielectric layer including an anodized material of the sustain electrode on a surface of the sustain electrode not contacting the front substrate; a rear panel facing the front panel, and including a rear substrate, an address electrode on a surface of the rear substrate facing the front substrate, and a second dielectric layer covering the address electrode; and a barrier rib partitioning a plurality of discharge cells between the front panel and the rear panel in a pattern.

Another embodiment of the present invention provides a fabricating method of a plasma display panel including: a front panel including a front substrate, a sustain electrode provided on a surface of the front substrate extending in one direction, and a first dielectric layer including an anodized material of the sustain electrode on a surface of the sustain electrode not contacting the front substrate; a rear panel facing the front panel and including a rear substrate, an address electrode formed on a surface of the rear substrate facing the front substrate, and a second dielectric layer covering the address electrode; and a barrier rib partitioning a plurality of discharge cells provided between the front panel and the rear panel in a pattern, the method including: forming a pattern for the sustain electrode and the first dielectric layer on the surface of the front substrate; and forming the sustain electrode and the first dielectric layer by anodizing an outer surface of the pattern for the sustain electrode and the first dielectric layer.

Another embodiment of the present invention provides a fabricating method of a plasma display panel including: forming a pattern for a sustain electrode and a first dielectric layer on a surface of a front substrate; forming the sustain electrode and the first dielectric layer by anodizing an outer surface of the pattern for the sustain electrode and the first dielectric layer; forming a front panel including the front substrate, the sustain electrode on the surface of the front substrate extending in one direction, and the first dielectric layer including anodized material of the sustain electrode on a surface of the sustain electrode not contacting the front substrate; forming a rear panel facing the front panel and including a rear substrate, an address electrode on ae surface of the rear substrate facing the front substrate, and a second dielectric layer covering the address electrode; and forming a barrier rib partitioning a plurality of discharge cells between the front panel and the rear panel in a certain pattern.

### BRIEF DESCRIPTION OF THE DRAWINGS

The accompanying drawings, together with the specification, illustrate exemplary embodiments of the present invention, and together with the description, serve to explain the principles of the present invention.

FIG. 1 is an exploded perspective view of a plasma display panel according to a first embodiment of the present invention;

FIG. 2 is a cross-sectional view taken along I-I′ line of FIG. 1;

FIG. 3 is an exploded perspective view of a plasma display panel according to a second embodiment of the present invention;

FIG. 4 is a cross-sectional view taken along III-III′ line of FIG. 3;

FIG. 5 is a cross-sectional view taken along II-II′ line of FIG. 3;

FIG. 6A is a plan view showing a sustain electrode according to the second embodiment of the present invention;

FIG. 6B is a cross-sectional view taken along IV-IV′ line of FIG. 6A;

FIG. 6C is a cross-sectional view taken along V-V′ line of FIG. 6A;

FIG. 7 is a plan view showing a modification example of a sustain electrode according to the second embodiment of the present invention; and

FIGS. 8A to 8H are cross-sectional views explaining a fabrication method according to the second embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit and scope of the present invention. Accordingly, the drawings and description are to be regarded as illustrative in nature and not restrictive. Like reference numerals designate like elements throughout the specification.

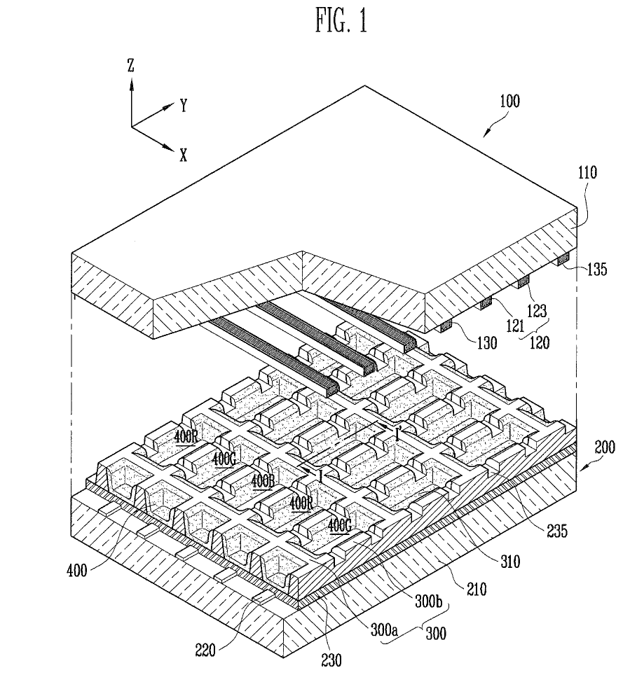

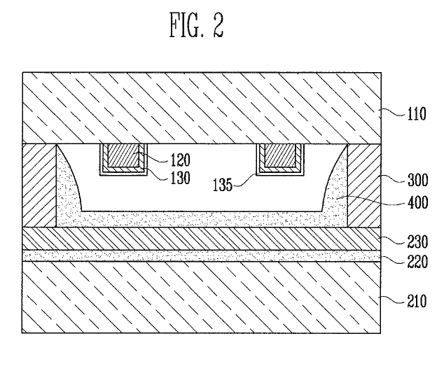

FIG. 1 is an exploded perspective view of a plasma display panel according to first embodiment of the present invention, and FIG. 2 is a cross-sectional view taken along I-I′ line of the FIG. 1.

Hereinafter, a front panel 100, which is different from a front substrate 110, refers to a panel including the front substrate 110, a sustain electrode 120 formed on the front substrate 110, and a first dielectric layer 130; and a rear panel 200, which is different from a rear substrate 210, refers to a panel including the rear substrate 210, an address electrode 220 formed on the rear substrate 210, and a second dielectric layer 230. In the following description, the same reference numerals will be used for the same components throughout for convenience.

The front panel 100 includes the front substrate 110, the sustain electrode 120, and the first dielectric layer 130.

The front substrate 110 and the rear substrate 210 are arranged to face each other at an interval (e.g., a predetermined interval), and discharge cells 310 arranged by color and formed by utilizing a barrier rib 300 are provided in a space between both substrates 110 and 210. In the discharge cell 310, a fluorescent (or phosphorous) layer 400 that is excited by ultraviolet rays to emit visible rays is formed on the surface of the barrier rib 300 and the bottom surface of the rear substrate 210. The discharge cell 310 is filled with a discharge gas (for example, a mixed gas including xenon (Xe), neon (Ne), etc.) in order to generate plasma discharge.

The front substrate 110 is formed of a transparent material, such as glass, capable of transmitting a visible ray to display an image.

The sustain electrodes 120 are formed on the inside surface of the front substrate 110, corresponding to the respective discharge cells 310 along one direction (x axis direction of FIG. 1). The sustain electrodes 120 include an X electrode 123 and a Y electrode 121 spaced apart from each other. The Y electrode 121 is utilized for selects a discharge cell 310 to be turned-on by operating with an address electrode 220, and the X electrode 123 generates sustain discharge for the selected discharge cell 310 by operating with the Y electrode 121.

In the surface where these sustain electrodes 120 are not in contact with the front substrate 110, a metal material constituting the sustain electrode 120 is covered with the first dielectric layer 130 formed of anodized dielectric. The first dielectric layer 110 reduces or prevents charged particles from directly impacting the sustain electrode 120 at the time of discharge to impair the sustain electrode 120, and performs a role inducing a formation of the charged particles.

The bottom of the first dielectric layer 130 can be covered with a protective film 135 formed of MgO, etc. The protective film 135 reduces or prevents charged particles from directly impacting the first dielectric layer 130 at the time of discharge to impair the dielectric layer 130, and serves to improve discharge efficiency by emitting second electrons (or secondary electrons) when the charged particles are impacted.

In the present embodiment, the sustain electrode 120 and the first dielectric layer 130 are positioned in the discharge cell 310 from a cross-sectional view taken along with an imaginary plane perpendicular to the panels.

Next, the rear panel 200 includes the rear substrate 210, the address electrode 220, and the second dielectric layer 230. On the upper surface of the rear substrate 210 opposing the front substrate 110, the address electrodes 220 extend in a direction crossing the sustain electrodes 120 (Y direction of FIG. 1), and the crossing regions are arranged corresponding to discharge cells 310. The address electrodes 220 are covered and buried by the second dielectric layer 230. The barrier rib 300 is formed in a pattern (e.g., a predetermined pattern) on the second dielectric layer 230.

The barrier rib 300 reduces or prevents cross talk between the neighboring discharges cells 310 by partitioning the discharge cells 310 that are the discharge space where the discharge occurs. The barrier rib 300 includes the barrier ribs 300a extending in the X direction and spaced apart from each other and the barrier ribs 300b extending in a Y direction and spaced apart from each other in a direction crossing the barrier ribs 300a in the X direction on the same plane, so that the discharges cells 310 have a close type structure.

The barrier rib 300b in the Y direction in the present embodiment has a groove 235 in the section corresponding to the sustain electrode 120 of the front panel 100, the first dielectric layer 130, and the protective film 135 in order to form the discharge cell 310 as a closed structure.

In the present embodiment, the barrier rib structure is one exemplary form. Therefore, the barrier rib structure may be in various other forms, such as a stripe-type barrier rib structure positioned between the address electrodes 220 and formed in the parallel direction with the address electrode 220.

The fluorescent layer 400 radiating visible rays excited by ultraviolet rays generated upon discharge is formed inside the discharge cells 310. The fluorescent layer 400 is formed on the second dielectric layer 230 and the wall surface of the barrier rib 300.

The fluorescent layer 400 is formed of one of red, green, and blue fluorescent bodies for color expression. For example, it may be divided into the red, green and blue fluorescent layers 400R, 400G, and 400B. The discharge cells 310 are filled with mixed discharge gas, including Neon (Ne), Xenon (Xe), etc.

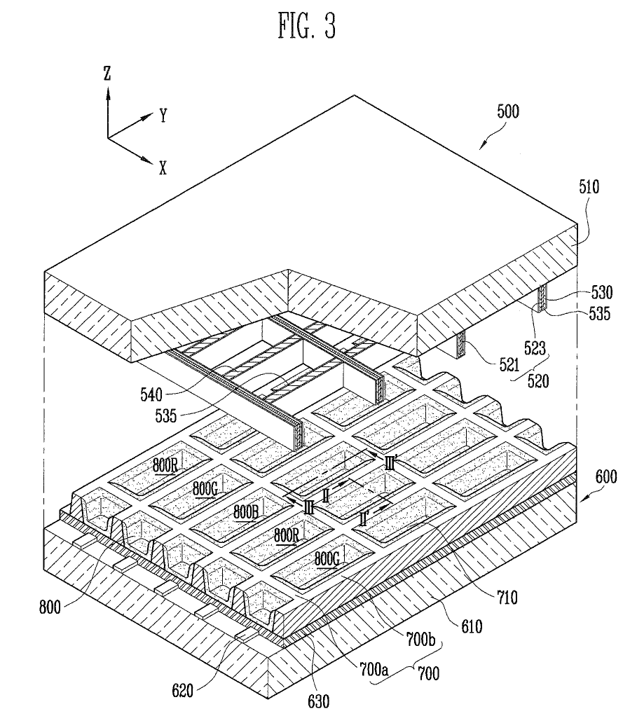

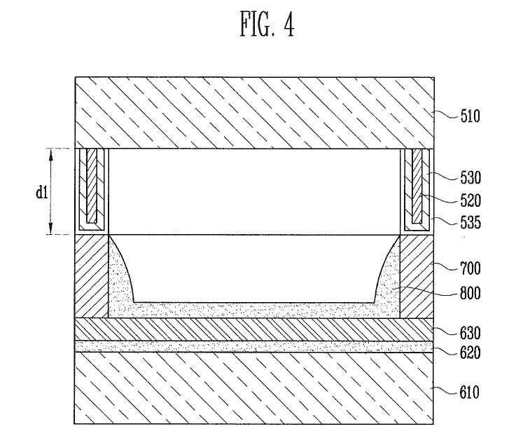

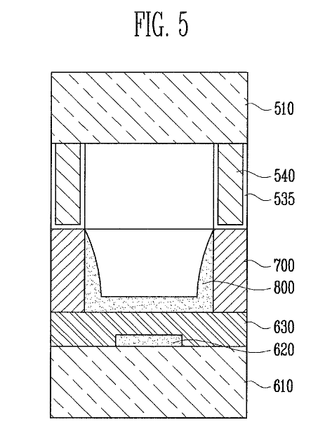

FIG. 3 is a partially exploded perspective view illustrating a plasma display panel according to a second embodiment of the present invention, FIG. 4 is a cross-sectional view taken along line III-III′ of FIG. 3, and FIG. 5 is a cross-sectional view taken along line II-II′ of FIG. 3.

A front panel 500 includes a front substrate 510, sustain electrodes 520, and a first dielectric layer 530.

The front substrate 510 is arranged opposite to a rear substrate 610 at a distance (e.g., a predetermined distance), with a space between both substrates 510 and 610 being provided with discharged cells 710 arranged by color formed by a barrier rib 700. A fluorescent (or phosphorous) layer 800 excited by ultraviolet rays to emit visible rays is formed along a barrier rib surface and a bottom surface in the discharge cell 710, and discharge gas is filled in the discharge cell to facilitate plasma discharge.

The front substrate 510 is made of transparent materials, such as glass, capable of transmitting visible rays in order to display images.

The sustain electrodes 520 are formed to correspond to each discharge cell 710 along one direction (x-axis direction of FIG. 3) within the front substrate 510. These sustain electrodes 520 include X electrodes 523 and Y electrodes 521. The X electrode 523 selects a discharge cell 710 to be turned on by being activated together with an address electrode 620 on the rear panel 600, and the Y electrode 521 leads to sustain discharge only for the discharge cell 710 selected by being activated with the X electrode 523.

A metal material forming the surface on which these sustain electrodes 520 do not contact the front substrate 510 is covered with the first dielectric layer 530 made of anodized dielectric. The first dielectric layer 530 reduces or prevents damage of these sustain electrode 520 due to a direct collision of charged particles on these sustain electrode 520 upon discharging and performs a role of inducing a formation of the charged particles.

A lower surface of the first dielectric layer 530 may be covered with a protective film 535 made of MgO, etc. The protective film 535 reduces or prevents damage of the first dielectric layer 530 due to a direct collision of charged particles on the dielectric layer 530 upon discharging, and, if the charged particles collide, and performs a role of improving discharge efficiency the emission of secondary electrons.

In the present embodiment, the sustain electrode 520 and the first dielectric layer 530 are positioned on the upper surface of a barrier rib 700a in an X direction from a cross-sectional view taken along a imaginary plane perpendicular to the panels 510, 610, and a barrier rib layer 540 is further provided on a barrier rib 700b in a Y direction where the sustain electrode 520 and the first dielectric layer 530 are not positioned.

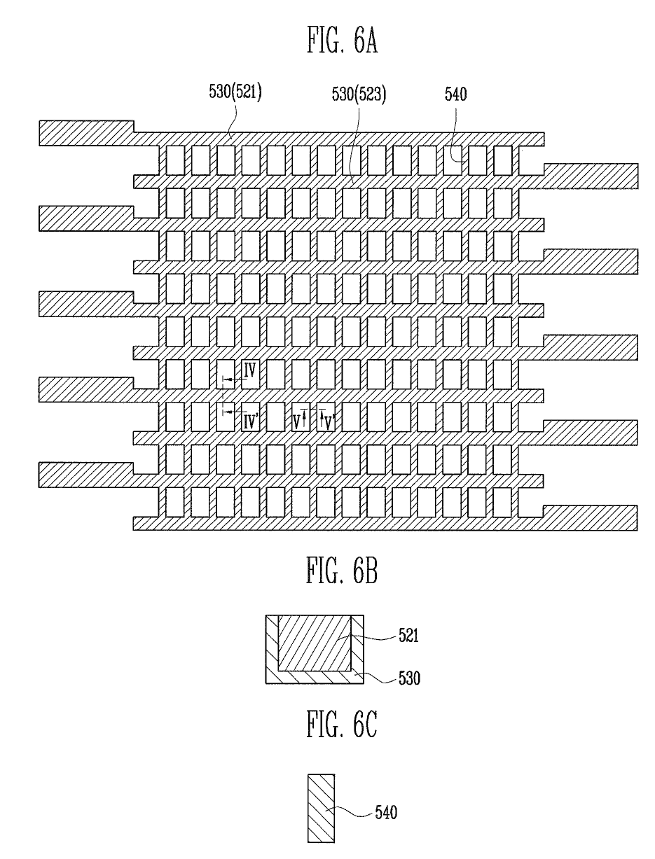

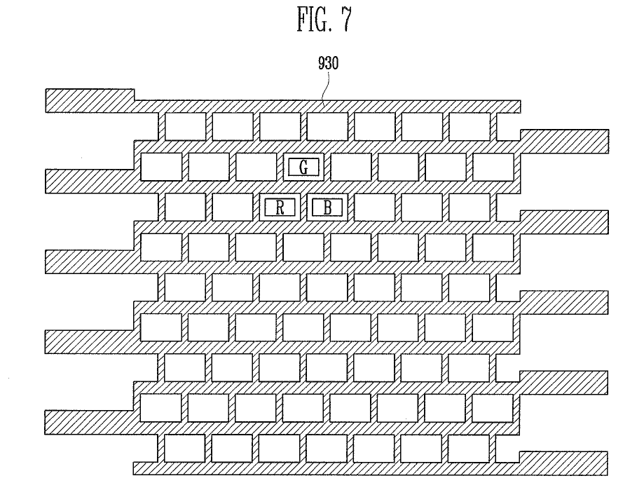

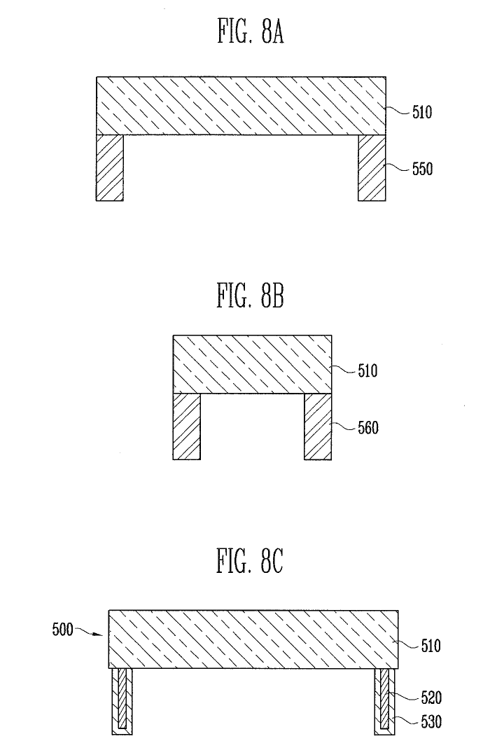

FIG. 6A is a plan view of the sustain electrode and the first dielectric layer formed on the front substrate 510 according to the second embodiment, FIG. 6B is a cross-sectional view taken along line IV-IV′ of FIG. 6A, and FIG. 6C is a cross-sectional view taken along line V-V′.

Referring to FIG. 6A to FIG. 6C, the X electrode 521 and the Y electrode 523 of the sustain electrode are arranged in parallel to extend in one direction, and the surfaces thereof are covered with the first dielectric layer 530 (in FIG. 6A, reference numerals of the X electrode and Y electrode are represented by 521 and 523 within a bracket). The barrier rib layer 540 is coupled in a direction crossing the sustain electrodes 521 and 523. From the cross-sectional view taken along a imaginary plane perpendicular to the panels, the cross-sectional area of the barrier rib layer 540 is smaller than the total cross-sectional area of the sustain electrode 521 or 523 and the first dielectric layer 530. The smaller cross-sectional area of the barrier rib layer 540 is to remove or reduce conductivity of the barrier rib layer 540 by anodizing the overall barrier rib 540 as described below.

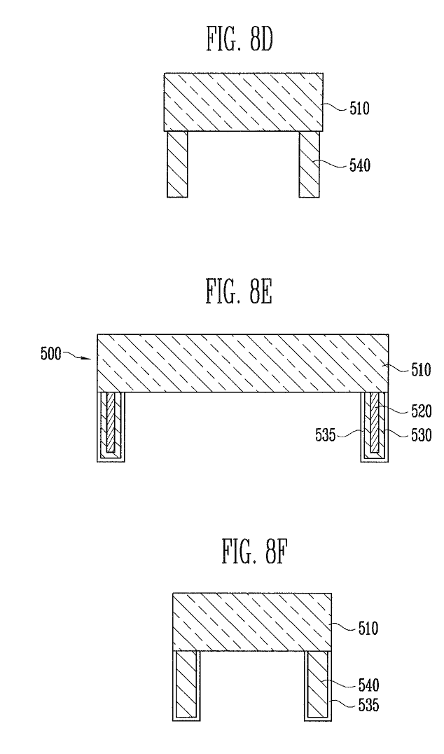

FIG. 7 shows a formation of a sustain electrode and a first dielectric layer 930 surrounding it according to an embodiment of the present invention when a pixel arrangement of the barrier ribs of the plasma display panel is a delta type. As such, those skilled in the art will appreciate that the present invention is not limited to a particular pixel arrangement.

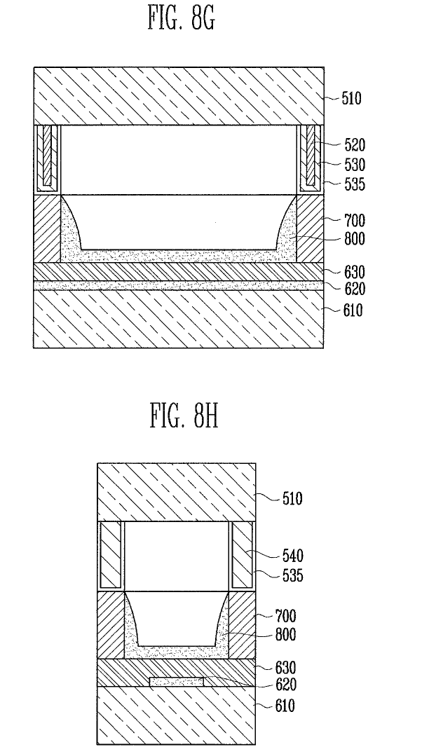

Hereinafter, a manufacturing method of a plasma display panel according to the second embodiment of the present invention will be described in more detail with reference to FIGS. 8A to 8G. Although the manufacturing method of the present invention will be described with reference to the second embodiment, those skilled in the art can easily practice the case of the first embodiment.

For convenience of explanation, the following drawings will describe cross-sectional views with reference to FIG. 3 that illustrates a completed embodiment. FIG. 8A is a cross-sectional view taken along line III-III′ of FIG. 3, and FIG. 8B is a cross-sectional view taken along II-II′ of FIG. 3.

First, as shown in FIGS. 8A and 8B, this step of the method forms the pattern 550 for forming the sustain electrode 520 and the first dielectric layer 530 on the front substrate 510 to be positioned in correspondence to the upper portion of the barrier rib in an X direction of the rear substrate 610, and the barrier rib pattern 560 for forming the barrier rib layer 540 on the remaining barrier rib in a Y direction on which the sustain electrode 520 and the first dielectric layer 530 are not positioned.

Since the first dielectric layer 530 and the barrier rib layer 540 are formed by anodizing the sustain electrode 520, the materials to be applied on the front substrate 510 are the same in the beginning. Therefore, the surface of the front substrate 510 is applied with the materials, and then patterned so that the pattern forming the sustain electrode 520 and the first dielectric layer 530, and the barrier rib pattern 560 forming the barrier rib layer 540 can be formed.

FIG. 8C is a cross-sectional view taken along line III-III′ of FIG. 3, and FIG. 8D is a cross-sectional view taken along line II-II′ of FIG. 3. As shown in FIGS. 8C and 8D, this step is for anodizing the pattern 550 forming the sustain electrodes 521 and 523 and the first dielectric layer 530, and the barrier rib pattern 560 forming the barrier rib layer 540 on the remaining barrier rib 770b on which the sustain electrodes 521 and 523 and the first dielectric layer 530 are not positioned.

From a cross-sectional view taken along the imaginary plane perpendicular to the panels, the cross-sectional area of the barrier rib pattern 560 is smaller than the cross-sectional area of the pattern to form one of the sustain electrodes 521 and 523 and the first dielectric layer 530. Thereby, the overall barrier rib pattern 560 is anodized during anodization, and the pattern 550 forming the sustain electrodes 521 and 523 and the first dielectric layer 530 is anodized to form only the first dielectric layer 530 so that the sustain electrodes 521 and 523 are provided therein.

FIG. 8E is a cross-sectional view taken along line III-III of FIG. 3, and FIG. 8F is a cross-sectional view taken along line II-II′ of FIG. 3. As shown in FIGS. 8E and 8F, this step is for forming the protective film 535 of materials, such as MgO, after the formation of the sustain electrodes 521 and 523, the first dielectric layer 530, and the barrier layer 540.

FIG. 8G is a cross-sectional view taken along line III-III′ of FIG. 3, and FIG. 8H is a cross-sectional view taken along line II-II′. As shown in FIGS. 8G and 8H, this step is for coupling the rear panel 600 facing the front panel 500 and including the rear substrate 610, the address electrode 620 formed on one surface of the rear substrate 610 opposing the front substrate 510, and a second dielectric layer 630 in which the address electrode 620 is buried (or embedded within), to the front panel 500. The manufacturing method of the rear panel is well known to those skilled in the art, and will not be described in detail.

The present invention is mainly described based on the embodiments, but various modifications and changes can be made without departing from the gist and scope of the present invention. For example, the protective film may be formed on the overall front substrate.

The plasma display panel according to an embodiment of the present invention has a structure where the sustain electrodes and the dielectric layer formed by anodizing the sustain electrode are provided on the front substrate so that the processes for manufacturing the front panel are reduced as compared to the related arts to facilitate the manufacture, making it possible to effectively reduce the manufacturing costs.

In particular, in the first embodiment, the distance between the sustain electrodes is reduced, thereby reducing the discharge voltage. Also, the second embodiment can reduce the discharge voltage (Vs) by increasing the opposing surface between the sustain electrodes as compared to the related arts, can sufficiently secure the light emitting region by increasing the distance between the sustain electrodes, and can improve the discharge efficiency by increasing the light transmission due to the exposure of the substrate of the discharge space.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel comprising:
a front panel comprising a front substrate, a sustain electrode on a surface of the front substrate extending in one direction and comprising an X electrode and a Y electrode, and a first dielectric layer comprising an anodized material of the sustain electrode on a surface of the sustain electrode not contacting the front substrate;
a rear panel facing the front panel, and comprising a rear substrate, an address electrode on a surface of the rear substrate facing the front substrate, and a second dielectric layer covering the address electrode; and
a barrier rib partitioning a plurality of discharge cells between the front panel and the rear panel in a pattern.

2. The plasma display panel as claimed in claim 1, wherein, with respect to a cross-sectional plane perpendicular to the front and rear panels, the sustain electrode and the first dielectric layer are inside a corresponding one of the discharge cells.

3. The plasma display panel as claimed in claim 1, wherein, with respect to a cross-sectional plane perpendicular to the front and rear panels, the sustain electrode and the first dielectric layer are on the barrier rib partitioning the discharge cells, and a barrier rib layer is on a portion of the barrier rib where the sustain electrode and the first dielectric layer are not positioned.

4. The plasma display panel as claimed in claim 3, wherein the barrier rib layer comprises an anodized material of the sustain electrode.

5. The plasma display panel as claimed in claim 3, wherein, with respect to a cross-sectional plane perpendicular to the front and rear panels, the cross-sectional area of the barrier rib layer is smaller than the total cross-sectional area of the sustain electrode and the first dielectric layer.

6. The plasma display panel as claimed in claim 5, wherein the barrier layer and the first dielectric layer comprise the same material.

7. The plasma display panel as claimed in claim 1, wherein the barrier rib partitions the discharge cells to be in a stripe arrangement or a delta arrangement.

8. The plasma display panel as claimed in claim 1, further comprising a protective film protecting the surface of the first dielectric layer.

9. A fabricating method of a plasma display panel comprising:
a front panel comprising a front substrate, a sustain electrode provided on a surface of the front substrate extending in one direction, and a first dielectric layer comprising an anodized material of the sustain electrode on a surface of the sustain electrode not contacting the front substrate;
a rear panel facing the front panel and comprising a rear substrate, an address electrode formed on a surface of the rear substrate facing the front substrate, and a second dielectric layer covering the address electrode; and
a barrier rib partitioning a plurality of discharge cells provided between the front panel and the rear panel in a pattern, the method comprising:
forming a pattern for the sustain electrode and the first dielectric layer on the surface of the front substrate; and
forming the sustain electrode and the first dielectric layer by anodizing an outer surface of the pattern for the sustain electrode and the first dielectric layer.

10. The fabricating method of the plasma display panel as claimed in claim 9, further comprising forming a protective layer on the first dielectric layer after forming the sustain electrode and the first dielectric layer.

11. The fabricating method of a plasma display panel as claimed in claim 9, further comprising forming the pattern for the sustain electrode and the first dielectric layer on the barrier rib partitioning the discharge cells and forming a barrier rib pattern for a barrier rib layer on a remaining portion of the barrier rib where the sustain electrode and the first dielectric layer are not positioned.

12. The fabricating method of a plasma display panel as claimed in claim 11, wherein the pattern for the sustain electrode and the first dielectric layer is anodized in a portion where the first dielectric layer is to be formed, and the barrier rib pattern for the barrier rib layer is wholly anodized.

13. The fabricating method of a plasma display panel as claimed in claim 12, wherein, with respect to a cross-section plane perpendicular to the front and rear panels, the cross-sectional area of the barrier rib pattern for the barrier rib layer is smaller than the total cross-sectional area of the pattern for the sustain electrode and the first dielectric layer.

14. A fabricating method of a plasma display panel comprising:
forming a pattern for a sustain electrode and a first dielectric layer on a surface of a front substrate;
forming the sustain electrode and the first dielectric layer by anodizing an outer surface of the pattern for the sustain electrode and the first dielectric layer;
forming a front panel comprising the front substrate, the sustain electrode on the surface of the front substrate extending in one direction, and the first dielectric layer comprising an anodized material of the sustain electrode on a surface of the sustain electrode not contacting the front substrate;
forming a rear panel facing the front panel and comprising a rear substrate, an address electrode on a surface of the rear substrate facing the front substrate, and a second dielectric layer covering the address electrode; and
forming a barrier rib partitioning a plurality of discharge cells between the front panel and the rear panel in a pattern.

15. The fabricating method of the plasma display panel as claimed in claim 14, further comprising forming a protective layer on the first dielectric layer after forming the sustain electrode and the first dielectric layer.

16. The fabricating method of a plasma display panel as claimed in claim 14, further comprising forming the pattern for the sustain electrode and the first dielectric layer on the barrier rib partitioning the discharge cells and forming a barrier rib pattern for a barrier rib layer on a remaining portion of the barrier rib where the sustain electrode and the first dielectric layer are not positioned.

17. The fabricating method of a plasma display panel as claimed in claim 16, wherein the pattern for the sustain electrode and the first dielectric layer is anodized in a portion where the first dielectric layer is to be formed, and the barrier rib pattern for the barrier rib layer is wholly anodized.

18. The fabricating method of a plasma display panel as claimed in claim 17, wherein, with respect to a cross-section plane perpendicular to the front and rear panels, the cross-sectional area of the barrier rib pattern for the barrier rib layer is smaller than the total cross-sectional area of the pattern for the sustain electrode and the first dielectric layer.
